(19) United States
(12) Patent Application Publication
(10) Pub. No.: US 2016/0170892 A1
(43) Pub. Date: Jun. 16, 2016

(54) EXPRESSION PATTERN MATCHING IN A STORAGE SUBSYSTEM

(71) Applicant: HGST NETHERLANDS B.V., Amsterdam (NL)

(72) Inventors: David Hall, Rochester, MN (US); Christopher Squires, Boulder, CO (US)

(21) Appl. No.: 14/566,999

(22) Filed: Dec. 11, 2014

(51) Int. Cl. G06F 12/08; G06F 17/27

(52) U.S. Cl. CPC G06F 12/0888; G06F 17/2705; G06F 2212/1021

(57) ABSTRACT

Described here in are systems, methods and software to manage content patterns in a storage subsystem. In one example, a storage subsystem to pattern match data objects includes a storage media that stores a plurality of data objects and a memory module configured to cache at least a portion of the plurality of data objects. The storage subsystem further includes a regular expression engine located in a read path between the storage media and the memory module configured to identify a data object in the read path from the storage media to the memory module. The regular expression engine is also configured to determine whether content of the data object matches a content pattern, and based on the content pattern cache the data object in the memory module or prevent the data object from being cached in the memory module.

### TECHNICAL BACKGROUND

A regular expression, sometimes referred to as a rational expression, is a sequence of characters that forms a search pattern, often used in the matching of strings. These regular expressions may be used in the computing sense to find one or more files, documents, directories, or other similar data object that fits a certain criteria. For example, a user may desire to search for all documents, files, or portions thereof that contain a particular word.

To accomplish the task of identifying the various data objects, the data objects are read from storage drives, such as hard disk drives or solid state drives, into a host processing system. This reading into the host processing system requires the data to be read from the drive storage media to the drive memory module, wherein the data may then be transferred to the host system. Once received by the host system, the host may execute the various functions necessary to identify the data objects that meet the user defined pattern. Although reading the data objects into the host processing system accomplishes the desired result, the various processes necessary to retrieve the data objects may be inefficient and require time that could be used in executing alternative tasks.

### OVERVIEW

Examples disclosed herein provide systems, methods and software to implement expression pattern matching in a storage subsystem. In one example, a storage subsystem to pattern match data objects includes a storage media that stores a plurality of data objects and a memory module configured to cache at least a portion of the plurality of data objects. The storage subsystem also includes a regular expression engine located in a read path between the storage media and the memory module configured to identify a data object in the read path from the storage media to the memory module. The regular expression engine is further configured to determine whether content of the data object matches a content pattern. If the content of the data object matches the content pattern, the regular expression engine transfers the data object to the memory module. In contrast, if the content of the data object does not match the content pattern, the regular expression engine prevents the data object from being transferred to the memory module.

In another instance, a computer apparatus to manage pattern matching in a storage subsystem includes processing instructions that direct a regular expression engine to identify a data object in a read path from a storage media to a memory module. The processing instructions further direct the regular expression engine to determine whether the content of the data object matches a content pattern. If the content of the data object matches the content pattern, the processing instructions direct the regular expression engine to transfer the data object to the memory module. In contrast, if the content of the data object does not match the content pattern, the processing instructions direct the regular expression engine to prevent the data object from being transferred to the memory module. The computer apparatus further includes one or more non-transitory computer readable media that store the processing instructions.

In a further example, a computing system includes a host system configured to execute a process that generates a content pattern, and transfer the content pattern to a regular expression engine within a storage subsystem. The computing system further includes the regular expression engine configured to receive the content pattern, identify a data object in a read path from a storage media to a memory module in the storage subsystem, and determine whether content of the data object matches the content pattern. The regular expression engine is further configured to, if the content of the data object matches the content pattern, transfer the data object to the memory module. The regular expression engine is also configured to, if the content of the data object does not match the content pattern, prevent the data object from being transferred to the memory module.

### BRIEF DESCRIPTION OF THE DRAWINGS

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 is a block diagram illustrating a storage subsystem to pattern match data objects.

FIG. 2 is a flow diagram illustrating an operation of a regular expression engine.

FIG. 3 is a block diagram illustrating an operational scenario of a storage subsystem.

FIG. 4 is a block diagram illustrating an operational scenario of a storage subsystem.

FIG. 5 is a block diagram illustrating a computing system with a regular expression engine.

FIG. 6 is a block diagram illustrating an operational scenario of a computing system with a regular expression engine.

FIG. 7 is a block diagram illustrating a computing system with a plurality of storage subsystems.

FIG. 8 is a block diagram illustrating a regular expression engine computing system.

### DETAILED DESCRIPTION

Storage subsystems, such as hard disk drives and solid state drives, are often used in computing systems to store data objects for processing within a host processing system. Accordingly, when a data object is required for processing within the host system, the object may be temporarily cached within the drives memory before being transferred for processing. Here, rather than requiring all of the processing to be accomplished within a host, at least a portion of the processing may be offloaded to the storage subsystem.

In particular, the storage subsystem may be outfitted with a regular expression engine that may be used to pattern match or search various data objects for particular strings of characters. These data objects may include files, documents, directories, or other similar data objects, including portions thereof. For example, if a user or some other requesting system desired all data objects with a particular string, the regular expression engine located within the storage subsystem may be configured to search for the particular string. Thus, a host system may be able to offload some of the processing requirements onto the storage subsystems, increasing efficiency within the host.

To further demonstrate the implementation of regular expression engines within a storage subsystem, FIG. 1 is provided. FIG. 1 is a block diagram 100 illustrating a storage subsystem 110 capable of pattern matching data objects. Storage subsystem includes storage media 101, regular expression engine 102, and memory 103. Storage media 101 is communicatively coupled to regular expression engine 102, and regular expression engine 102 is further communicatively coupled to memory 103.

Storage media 101 may include various types of storage media including hard disk media, solid state media, or other similar types of media, including improvements thereof. Regular expression engine 102 may include a system on chip (SOC), a field programmable gate array (FPGA), a microcontroller or processing system, or any other similar integrated circuit. Memory 103 may include various forms of random access memory (RAM), dynamic random-access memory (DRAM), or some other form of caching memory used to temporarily store data objects and portions thereof for storage subsystem 110.

In operation, regular expression engine 102 performs pattern matching operations using a defined regular expression. In particular, a user or some other search process may identify a regular expression that is to be identified in one or more data objects. These data objects may include files, documents, tables, or any other similar data objects, including combinations thereof. Once a regular expression is identified, the data objects stored within storage media 101 may be read from storage media 101 and transferred in a read path to be cached within memory 103. Here, as the data is read from storage media 101 to memory 103, regular expression engine 102 is used to identify or determine when content within the data object matches the defined regular expression. Based on this identification, the data object or at least a portion thereof, may be transferred to memory 103 to be cached.

In at least one example, storage subsystem 110 may include a hard disk drive or solid state drive. Accordingly, the drive may be attached to a host processing system capable of processing the data stored within storage media 101. Further, to offload some of the processing requirements for the host processing system, the regular expression functions that would otherwise be accomplished using host processing clock cycles may be offloaded to storage subsystem 110.

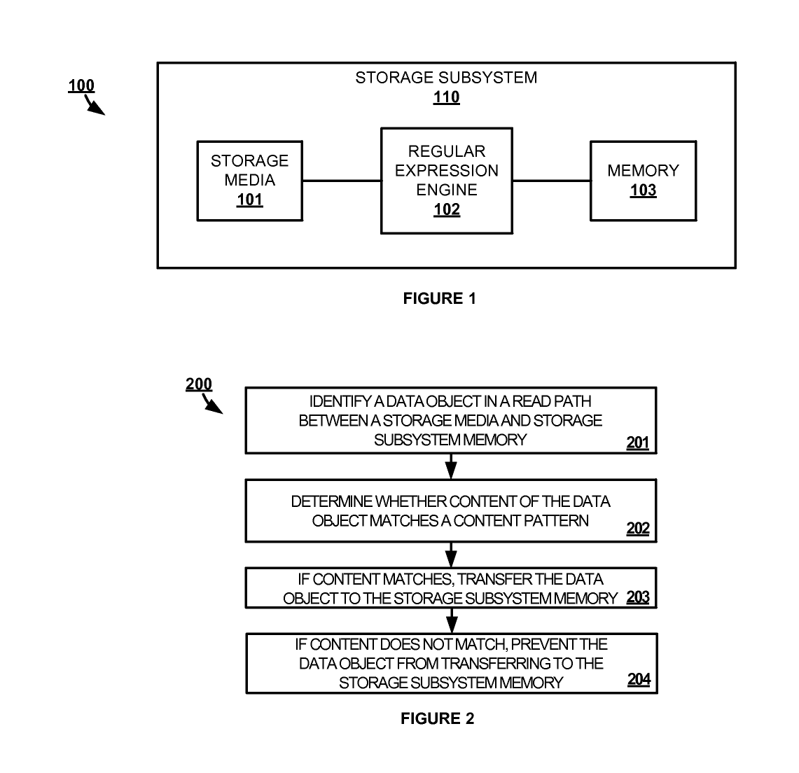

As a further illustration of the operation of storage subsystem 110, FIG. 2 is included. In particular, FIG. 2 is a flow diagram 200 illustrating an operation of regular expression engine 102. As depicted, regular expression engine 102 identifies a data object in a read path between storage media 101 and memory 103 (201). Responsive to identifying the data object, regular expression engine 102 determines whether content of the data object matches a content pattern (202). An administrator, a management process, or some other management mechanism capable of generating regular expressions to be applied to data in storage media 101 may define this content pattern. In some instances, the regular expressions may be generated from a host system that is communicatively coupled to storage subsystem 110. In particular, in the case of a server, desktop, or other similar computing device, an application executing on the device may generate a regular expression that needs to be applied to data stored in storage subsystem 110. Responsive to the user or automated request in the application, a configuration may be transferred to regular expression engine 102 to pattern match specific content within the data objects.

Once it is determined that a data object includes content that matches the prescribed content pattern, the data object may be transferred by regular expression engine 102 to memory 103 (203). In contrast, if it is determined that the content of the data object does not match the content pattern, regular expression engine 102 prevents the data object from being transferred to memory 103 (204). In some examples, this halting of the data object at regular expression engine 102 may include preventing the data object from being written to memory 103. Once rejected, regular expression engine may, in some instances, transfer a notification to memory 103 indicating that the data object was rejected. Accordingly, rather than writing every data object to memory 103, writes may be objected to prior to making each write. Further, rather than passing each of the data objects to a host processing system, the host processing system may be able to offload the regular expression calculations to a processing system located in the storage subsystem.

Although described above as pattern matching all content within a data object, it should be understood that in some examples indexing may be used for each of the data objects. For example, strings of symbols, such as words or phrases, for each data object may be organized in an index for the data object. Accordingly, as a data object is read from media 101, regular expression engine 102 may compare a regular expression to the strings defined in the index. If the regular expression is found in the index, regular expression engine 102 may forward the object to memory 103 for caching. In contrast, if the regular expression does not exist in the index, the object may be prevented from being cached in memory 103.

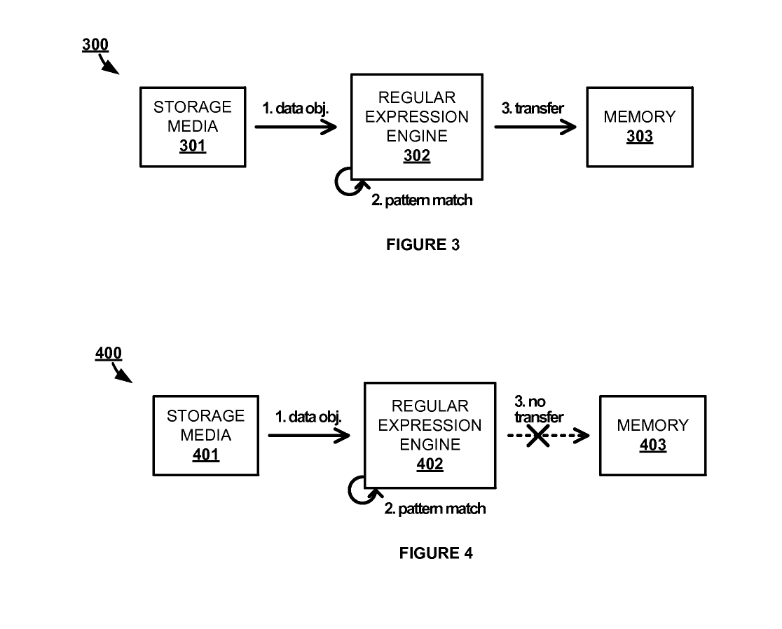

Referring to FIG. 3, FIG. 3 is a block diagram 300 illustrating an operational scenario of a storage subsystem. Block diagram 300 includes storage media 301, regular expression engine 302, and memory 303. As illustrated in the storage subsystem, regular expression engine 302 may be used to filter or manage data objects as they are read from storage media 301 into memory 303. To manage the data objects, regular expressions or various strings of symbols may be applied to the data objects as they are transferred along a read path from storage media 301.

Once a data object is read and identified by regular expression engine 302, regular expression engine 302 will pattern match or apply the particular pattern to the content of the data object. For example, a user may attempt to identify all documents with a particular word. As a result, when the documents are read from storage media 301, regular expression engine 302 will pattern match the documents for the particular word. Once the pattern match is applied and the particular content is identified within the object, the object may be transferred and written to memory 303.

In some examples, the storage subsystem may be connected to a host processing system, such as a microprocessor or some other similar processing unit. This processing unit may include the ability to execute various applications and processes within a desktop, laptop, server, tablet, or other similar computing device. As the applications and processes execute, a regular expression may be required to identify particular data objects within the storage media. Rather than using the host processing system to handle the pattern matching, the user, the application, or some other automated process may configure regular expression engine 302 to execute the pattern matching functions.

FIG. 4 is a block diagram 400 illustrating an operational scenario of a storage subsystem. Block diagram 400 is an example of applying a pattern match to a data object, and preventing the data object from being written to the storage subsystem memory. Block diagram 400 includes storage media 401, regular expression engine 402, and memory 403. In some examples, block diagram 400 is an example of a storage drive, such as hard disk drive or a solid state drive.

In operation, various data objects may be read from storage media 401 for possible storage into memory 403. Here, instead of directly storing the objects into memory 403, regular expression engine 402 is included in the read path between storage media 401 and memory 403. As a data object is read from storage media 401, regular expression engine 402 is configured to pattern match content of the data object to a desired expression. For example, regular expression engine 402 may be configured to match or identify a particular word or expression within each data object as it is read from storage media 401. If the word does not exist, as illustrated in FIG. 4, regular expression engine 402 may prevent the object or portions of the object from being written to memory 403. Thus, rather than writing all data objects to memory 403 within the storage subsystem, and transferring the objects to a host processing system to identify matches, regular expression operations may be performed prior to the object being written to the storage subsystem memory.

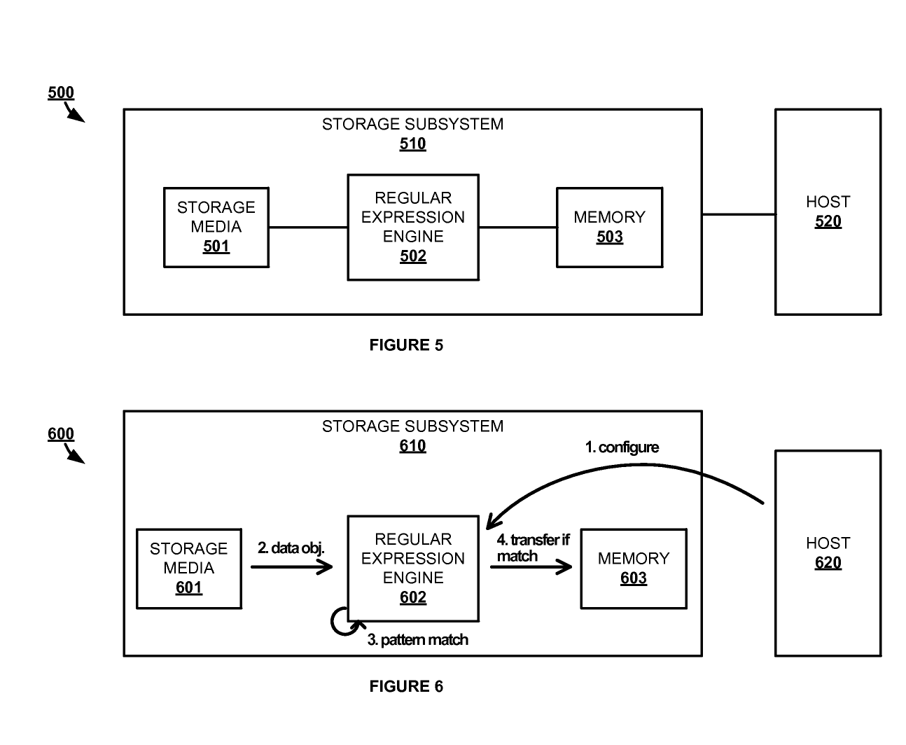

As a further demonstration of implementing a regular expression engine in a storage subsystem, FIG. 5 is provided. FIG. 5 is a block diagram 500 illustrating a computing system with a regular expression engine. Block diagram 500 is an example of a desktop, server, laptop, tablet, smart telephone, or some other similar computing system. Block diagram 500 includes storage subsystem 510 and host 520. Storage subsystem 510 is an example of a storage drive, such as a hard disk drive, solid state drive, or some other similar storage drive, including improvements thereof. Storage subsystem 510 includes storage media 501, regular expression engine 502, and memory 503. Host 520 is an example of a centralized processing system, which may include memory and one or more processing devices. Storage subsystem 510 is communicatively coupled to host 520 using a Small Computer System Interface (SCSI) bus, a Serial Attached SCSI (SAS) bus, a Serial ATA (SATA) bus, a Peripheral Component Interconnect Express (PCIe) bus, Fibre Channel, or some other similar interface or bus.

In operation, host 520 may access one or more data objects from storage media 501 to perform various tasks. To make the data objects available to host 520, a request may be transferred storage subsystem 510, which in turn will read the data objects to memory 503 before transferring the data to host 520. Here, included with storage subsystem 510 is regular expression engine 502. Regular expression engine 502 identifies data objects in the read path between storage media 501 and memory 503, and applies pattern matching operations to the data objects. For example, if one or more documents were stored in storage media 501, regular expression engine 502 may be used to identify one or more of the documents that include a particular string of symbols. If a data object included the string, the object may be transferred to memory 503 for caching. In contrast, if the data object did not include the pattern required for regular expression engine 502, regular expression engine 502 may reject the data object and prevent the data object from being cached in memory 503.

By including regular expression engine 502, host 520 may offload various processes to the storage subsystems communicatively coupled to the host. Thus, if an application required objects with particular content, regular expression engine 502 may be used to process the data before providing the data to host 520 preventing wasted data writes and transfers to the host. Further, although a single storage subsystem is included in the present example, it should be understood that any number of storage subsystems might be attached to host 520. For example, in some computing systems, large numbers of data objects may be stored on a plurality of storage subsystems or drives located on or communicatively coupled to the host. Accordingly, if content is requested by an application executing on the host, regular expression engines within each of the storage systems may be configured to pattern match the various content and respond to the host requests.

Turning to FIG. 6, FIG. 6 is a block diagram 600 illustrating an operational scenario of a computing system with a regular expression engine. The computing system in block diagram 600 is an example of a server, desktop, laptop, tablet, smart telephone, or any other similar computing system. Block diagram 600 includes storage subsystem 610 and host 620. Storage subsystem 620 is an example of a storage drive, such as a hard disk drive, solid state drive, or some other similar storage drive. Storage subsystem 610 includes storage media 601, regular expression engine 602, and memory 603. Host 620 may include one or more centralized processing units, as well as memory to store various data objects and processing instructions. Storage subsystem 610 is communicatively coupled to host 620 using SCSI, SAS, SATA, PCIe, Fibre Channel, or some other similar interface or bus, including improvements thereof.

Here, host 620 offloads one or more processes to regular expression engine 602 that allows regular expression engine to perform operations on data objects from storage media 601 without reading the data into the host. In particular, host 620 configures regular expression engine 602 to perform pattern matching operations on data objects as they are read from storage media 601. Accordingly, if host 620 required all data objects with a particular content pattern, regular expression engine 602 may provide the qualifying data objects while preventing the other non-qualifying objects from being provided to host 620.

As illustrated in storage subsystem 610, once a configuration is transferred from the host either through an automated process or user specified condition, a data object may be read from storage media 601. Once read, the data object is provided to regular expression engine 602. Regular expression engine 602 may comprise a system on chip, an FPGA, a microprocessor, or some other processing module capable of performing pattern matching operations. As a result, in response to receiving the data object, regular expression engine identifies if content within the data object matches the specified pattern as prescribed in the configuration from host 620.

For example, a user on host 620 may require all files that contain a particular string of characters. To identify the files, the application, the user, or another process on host 620 may generate a configuration for regular expression engine 602. Once configured, data objects may be read from storage media 601 and processed by regular expression engine 602 to determine if content within the data object matches the particular set of characters. If content does match, the object may be forwarded to memory 603 for caching. In contrast, if the content does not match, the object may be prevented from being passed and written to memory 603. Thus, rather than providing data objects from storage media 601 to host 620 for processing, regular expression engine 602 may be used to offload some of the processing before the data is loaded into the host.

In some examples, by implementing regular expression engine 602, a computing system may reduce the number of operations executed by the host and reduce the number of writes to memory on both host 620 and memory 603. For example, as described previously, once a data object is rejected based on pattern matching, the data object is prevented from being written to the drive memory. In turn, by not caching the data in the drive memory, the host is no longer required to cache and process the data object.

In some examples, as the various data objects are cached into memory 603, host 620 may request and receive the various data objects that fulfill the required pattern. Consequently, although the regular expression operations may occur within the storage subsystem itself, other application operations may occur using the host processing system and memory.

In some instances, the configuration capabilities may be included within a particular application or process that is executing on the host. This application or process may include processing instructions capable of identifying a storage subsystem with regular expression capabilities and configuring the regular expression engine to accomplish specific tasks. This application may include a large data processing application, such as structured query language (SQL) application, a Hadoop application, or any other similar large data processing application.

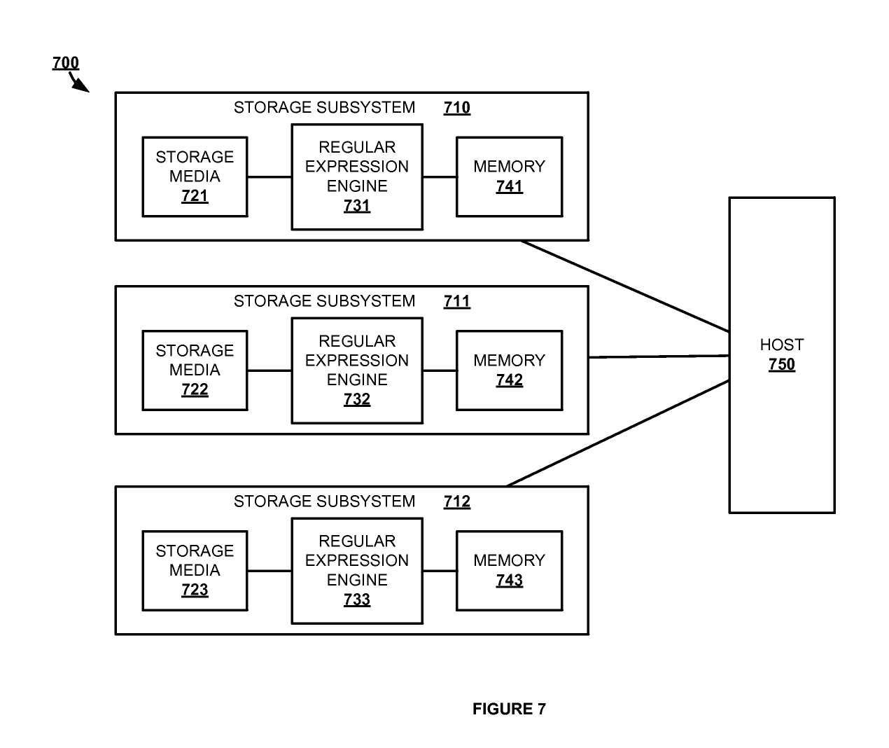

FIG. 7 is a block diagram 700 illustrating a computing system with a plurality of storage subsystems. Block diagram 700 is an example of a desktop, server, laptop, tablet, smartphone, or any other computing system with multiple available storage subsystems. Block diagram 700 includes storage subsystems 710-712 and host 750. Storage subsystems 710-712 further include storage media 721-723, regular expression engines 731-733, and memory 741-743. In some examples, storage subsystems 710-712 represent storage drives, such as hard disk drives or solid state storage drives, which are communicatively coupled to a centralized processing system or host 750. Host 750 may include one or more processing systems and memory to execute various applications and processes to accomplish specific tasks.

Here, host 750 is configured to execute at least one application capable of offloading pattern matching operations to regular expression engines 731-733. This application may include a SQL application, a Hadoop application, or any other large data processing application. In some examples, the application may first identify the various storage subsystems available to host 750 to offload pattern matching operations. Once identified, a configuration may be transferred to regular expression engines 731-733 to be implemented in processing a plurality of data objects from storage media 721-723.

In response to configuring regular expression engines 731-733, one or more data objects may be read from storage media 721-723. Once read, the data objects are transferred, along a read path, to regular expression engines 731-733. As the data objects are received, regular expression engines 731-733 compare content in the data objects to the desired content pattern. If a data object contains the desired content pattern, the data object is forwarded to one of memory 741-743. However, if a data object does not contain the desired content pattern, the data object is prohibited from moving forward and is not cached in one of memory 741-743. Once a data object is cached in memory 741-743 the data may then be retrieved by host 750 for further processing using the centralized processing system.

By offloading some of the pattern matching responsibilities, each of the storage subsystems may only present the data that is necessary for the application. Thus, rather than pattern matching in a centralized processing system, each of the storage subsystems may be used in parallel to identify data objects stored within the various storage medias.

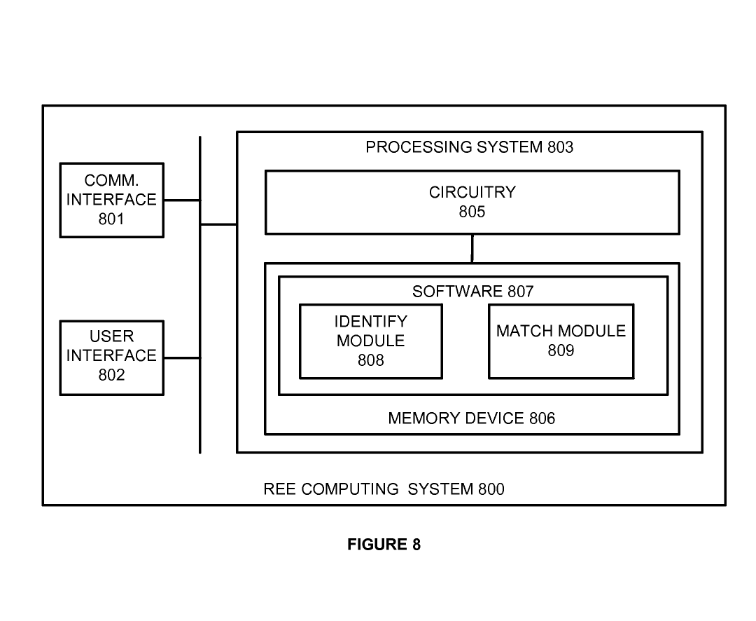

FIG. 8 is a block diagram 800 illustrating a regular expression engine (REE) computing system 800. REE computing system 800 is representative of a computing system that may be employed in any computing apparatus, system, or device, or collections thereof, to suitably implement the regular expression engines described herein. REE computing system 800 may comprise a system on chip in some examples, and may be located within a storage subsystem, such as a hard drive or solid state drive. Computing system 800 comprises communication interface 801, user interface 802, and processing system 803. Processing system 803 is communicatively linked to communication interface 801 and user interface 802. Processing system 803 includes processing circuitry 805 and memory device 806 that stores operating software 807.

Communication interface 801 comprises components that communicate over communication links, such as network cards, ports, RF transceivers, processing circuitry and software, or some other communication devices. Communication interface 801 may be configured to communicate over metallic, wireless, or optical links. Communication interface 801 may be configured to use TDM, IP, Ethernet, optical networking, wireless protocols, communication signaling, or some other communication format—including combinations thereof. In particular, communication interface 801 may communicate with a storage media and storage subsystem memory to act as an intermediary in a read path between the storage media and the storage subsystem memory.

User interface 802 comprises components that interact with a user. User interface 802 may include a keyboard, display screen, mouse, touch pad, or some other user input/output apparatus. User interface 802 may be omitted in some examples.

Processing circuitry 805 comprises microprocessor and other circuitry that retrieves and executes operating software 807 from memory device 806. Memory device 806 comprises a non-transitory storage medium, such as a disk drive, flash drive, data storage circuitry, or some other memory apparatus. Operating software 807 comprises computer programs, firmware, or some other form of machine-readable processing instructions. Operating software 807 includes identify module 808 and match module 809, although any number of software modules may provide the same operation. Operating software 807 may further include an operating system, utilities, drivers, network interfaces, applications, or some other type of software. When executed by circuitry 805, operating software 807 directs processing system 803 to operate REE computing system 800 as described herein.

In particular, identify module 808 is configured to identify data objects as they are transferred in a read path to storage subsystem memory. The data objects may include files, directories, documents, spreadsheets, or any other similar data object, including combinations and portions thereof. As a data object is identified, match module 809 is configured to identify whether content in the identified data object matches a configured regular expression. If content does match the regular expression, REE computing system 800 may provide the content to the storage subsystem memory. In contrast, if the content does not match the regular expression, REE computing system may prevent the data object from being cached within the storage subsystem memory.

In some examples, the storage subsystem may be communicatively coupled to a host processing system that may include one or more processors and memory to execute applications and processes. In these applications, it may be desired to identify all data objects that meet a regular expression pattern. For example, a user of the host processing system may desire to identify all documents with a particular word. Once the request is made, the host application may configure REE computing system 800 to identify the particular word. Accordingly, rather than providing each of the data objects to the host processing system for pattern matching operations, the pattern matching may be done within the storage subsystem before providing the results to the host system. By offloading some of the processing tasks, the processing system of the host may possess more resources to execute other necessary tasks.

In some instances, the application executing on the host may be configured to identify whether storage subsystems include the ability to offload regular expression operations. For example, the application may include processing instructions that verify pattern matching ability within the storage subsystem. If the ability does not exist, the application may complete the processing using the host processing system. However, if the ability to offload the operations does exist, the application may offload regular expression operations to any of the available storage subsystems.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A storage subsystem to pattern match data objects, the storage subsystem comprising:
a storage media that stores a plurality of data objects;
a memory module configured to cache at least a portion of the plurality of data objects; and
a regular expression engine located in a read path between the storage media and the memory module, the regular expression engine configured to:
identify a data object in the read path from the storage media to the memory module;
determine whether content of the data object matches a content pattern;
if the content of the data object matches the content pattern, transfer the data object to the memory module; and
if the content of the data object does not match the content pattern, prevent the data object from being transferred to the memory module.

2. The storage subsystem of claim 1 wherein the storage media comprises solid state storage media.

3. The storage subsystem of claim 1 wherein the storage media comprises one or more hard disks.

4. The storage subsystem of claim 1 wherein the regular expression engine configured to prevent the data object from being transferred to the memory module is configured to prevent writing of the data object to the memory module.

5. The storage subsystem of claim 1 wherein the regular expression engine is further configured to receive the content pattern from a host system.

6. The storage subsystem of claim 1 wherein the memory module comprises dynamic random-access memory.

7. The storage subsystem of claim 1 wherein the regular expression engine is further configured to, if the content of the data object does not match the content pattern, transfer a notification to the memory module indicating the content does not match the content pattern.

8. A computer apparatus to manage pattern matching in a storage subsystem, the computer apparatus comprising:
processing instructions that direct a regular expression engine, when executed by the regular expression engine, to:
identify a data object in a read path from a storage media to a memory module within the storage subsystem;
determine whether content of the data object matches a content pattern;
if the content of the data object matches the content pattern, transfer the data object to the memory module; and
if the content of the data object does not match the content pattern, prevent the data object from being transferred to the memory module; and
one or more non-transitory computer readable media that store the processing instructions.

9. The computer apparatus of claim 8 wherein the storage media comprises solid state storage media.

10. The computer apparatus of claim 8 wherein the storage media comprises one or more hard disks.

11. The computer apparatus of claim 8 wherein the processing instructions to prevent the data object from being transferred to the memory module direct the regular expression engine to prevent writing the data object to the memory module.

12. The computer apparatus of claim 8 wherein the processing instructions further direct the regular expression engine to receive the content pattern from a host system.

13. The computer apparatus of claim of claim 12 wherein the processing instructions to receive the content pattern from the host system direct the regular expression engine to receive the content pattern from an application executing on the host computing system.

14. The computer apparatus of claim 8 wherein the processing instructions to determine whether the content of the data object matches the content pattern direct the regular expression engine to determine whether indexing data associated with the data object matches the content pattern.

15. A computing system to offload pattern matching operations, the computing system including:
a host system configured to:
execute a process that generates a content pattern;
transfer the content pattern to a regular expression engine within a storage subsystem;
the regular expression engine configured to:
receive the content pattern;
identify a data object in a read path from a storage media to a memory module in the storage subsystem;
determine whether content of the data object matches the content pattern;
if the content of the data object matches the content pattern, transfer the data object to the memory module; and
if the content of the data object does not match the content pattern, prevent the data object from being transferred to the memory module.

16. The computer apparatus of claim 15 wherein the memory module is further configured to receive the data object and cache at least one portion of the data object for access by the host system.

17. The computer apparatus of claim 15 wherein the storage media comprises solid state storage media.

18. The computing system of claim 15 wherein the storage media comprises one or more hard disks.

19. The computing system of claim 15 wherein the storage subsystem comprises one of a solid state drive or a hard disk drive.

20. The computing system of claim 15 wherein the process comprises an application, and wherein the host system configured to execute the process that generates the content pattern is configured to execute the application and identify the content pattern from a user of the application.
